(19) United States
(12) Patent Application Publication
(10) Pub. No.: US 2025/0323527 A1
(43) Pub. Date: Oct. 16, 2025

(54) WIRELESS CHARGER

(71) Applicant: INNOPEAK TECHNOLOGY, INC., Palo Alto, CA (US)

(72) Inventors: Trevor Hudson, Palo Alto, CA (US); Timothy Weadon, Palo Alto, CA (US)

(21) Appl. No.: 19/041,149

(22) Filed: Jan. 30, 2025

Related U.S. Application Data
(60) Provisional application No. 63/548,750, filed on Feb. 1, 2024.

(51) Int. Cl. H02J 50/10; H02J 7/00; H02J 50/00; H02J 50/90

(52) U.S. Cl. CPC H02J 50/10; H02J 7/0044; H02J 50/005; H02J 50/90

(57) ABSTRACT

A wireless charger includes a mounting part; a transmit coil, disposed in the mounting part; a charging platform, adjacent to the mounting part, for placing a wearable device with a receive coil; a plurality of steps created on a top surface of the charging platform such that the plurality of steps are at different heights with respect to a horizontal plane; and a power circuit, coupled to the transmit coil to enable the transmit coil to emit electromagnetic waves to the receive coil to charge the wearable device.

### CROSS-REFERENCE TO RELATED APPLICATION

This application claims priority to U.S. Provisional Application No. 63/548,750, filed on Feb. 1, 2024. The entire disclosure of this application is incorporated herein by reference.

### BACKGROUND OF DISCLOSURE

### 1. Field of the Disclosure

The present disclosure relates to charging technologies, and more particularly, to a wireless charger.

### 2. Description of the Related Art

Existing inductive smart ring chargers on the market sell one charger model for each ring size, resulting in increased costs and complexity. Other proposed inductive chargers on the market use one smaller charging base for half the sizes and one for the other half, a compromise solution that partly solves the problem but may use additional circuit components and cost to achieve. Chargers can also connect via metal pins, which enables a one-size-fits-all solution. However, pin charging has its own disadvantages such as decreased aesthetic value and a gap in the ring's potting material that can make the structure less robust. The various drawbacks for each attempted strategy in the prior art depend on their methods. Generally, there exist no smart ring chargers to our knowledge which are size-agnostic, non-complex, and inductive.

### SUMMARY

In a first aspect of the present disclosure, a wireless charger, comprising a mounting part; a transmit coil, disposed in the mounting part; a charging platform, adjacent to the mounting part, for placing a wearable device with a receive coil; a plurality of steps created on a top surface of the charging platform such that the plurality of steps are at different heights with respect to a horizontal plane; and a power circuit, coupled to the transmit coil to enable the transmit coil to emit electromagnetic waves to the receive coil to charge the wearable device.

In some embodiments, the smaller the distance between the steps and the transmit coil, the smaller the heights of the steps.

In some embodiments, an overlap of a projection of the receive coil onto the transmit coil is compensated by a separation distance between the receive coil and the transmit coil.

In some embodiments, as the separation distance decreases between the transmit coil and the receive coil, the overlap of the projection of the receive coil onto the transmit coil decreases.

In some embodiments, the receive coil is disposed at a side of the wearable device close to the transmit coil.

In some embodiments, each of the steps has a concave surface or convex surface, on which the wearable device is placed.

In some embodiments, the mounting part is in a form of an hourglass.

In some embodiments, the wireless charger is for different sizes of the wearable device.

In some embodiments, the wearable device is a wearable ring.

In a second aspect of the present disclosure, a wireless charger, comprising a mounting part; a transmit coil, disposed in the mounting part; a charging platform, adjacent to the mounting part, for placing a wearable device with a receive coil; a distance sensor, for obtaining a separation distance between the transmit coil and the receive coil; and a power circuit, coupled to the transmit coil to enable the transmit coil to emit electromagnetic waves to the receive coil to charge the wearable device, wherein the power circuit adjusts transmit power based on the separation distance.

In some embodiments, the distance sensor comprises an infrared receiver disposed in the mounting part.

In some embodiments, the infrared receiver receives a signal from an infrared transmitter disposed in the wearable device to determine the separation distance.

In some embodiments, the distance sensor comprises multiple indictive proximity sensors disposed beneath the charging platform.

In some embodiments, the separation distance is determined by using the multiple indictive proximity sensors to detect presence of the wearable device with a metal shell.

In some embodiments, the receive coil is disposed at a side of the wearable device close to the transmit coil.

In some embodiments, the mounting part is in a form of an hourglass.

In some embodiments, the wireless charger is for different sizes of the wearable device.

In some embodiments, the wearable device is a wearable ring.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram showing alternative size-agnostic charger design using two alignment volumes.

FIG. 2 is a schematic diagram showing a horizontal cross section of a smart ring.

FIG. 3 is a schematic diagram showing that receive coils' coaxial misalignment (separation distance) will vary with ring size.

FIG. 4 is a diagram showing mutual inductance between two coils is affected by their coaxial (FIG. 4A) and lateral misalignment (FIG. 4B).

FIG. 5 shows a wireless charger for charging a smart ring according to an embodiment of the present disclosure.

FIG. 6 shows a cross-section of a smart ring and charging base, in which FIG. 6A depicts that Tx-Rx overlap is 100%, FIG. 6B depicts that Tx-Rx overlap is 93%, FIG. 6C depicts that Tx-Rx overlap is 84%, and FIG. 6D depicts that Tx-Rx overlap is 73%.

FIG. 7 shows a wireless charger including an infrared distance sensor instrument which can be used to estimate the normalized separation distance between the Tx and Rx coils, in which FIG. 7A depicts that the normalized separation distance is equal to 1, FIG. 7B depicts that the normalized separation distance is equal to 0.8, FIG. 7C depicts that the normalized separation distance is equal to 0.6, and FIG. 7D depicts that the normalized separation distance is equal to 0.4.

FIG. 8 shows a wireless charger including inductive proximity sensors which can be used to detect the metal ring housing, in which FIG. 8A depicts that the metal ring housing is located far away from the Tx coil, and FIG. 8B depicts that the metal ring housing is closer to the Tx coil.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Some terms used in this disclosure are defined as below:

“Inductive” wireless charging—wireless charging technique that passes energy through the air between two conductive coils if they are sufficiently aligned. The coils need to have a low separation distance and are typically on scale of tens of millimeters in diameter to ensure an acceptable Q factor. The “Qi” protocol uses “inductive” charging.

“Resonant” wireless charging—in contrast to “inductive” charging, here the two coils are loosely coupled and can function with a higher separation distance. Power transfer is lower with this method. The power transfer method here is technically also inductive, but it is described as “resonant” in the jargon of the industry due to different frequency tuning of each coil.

“BOM—bill of materials”, the list of components used to manufacture a product.

The present disclosure provides a charging base unit that is designed to wirelessly recharge the battery in a wearable ring. The proposed solution uses physics principles and simple geometry to create a base unit which allows for charging without parasitic heating or other damage to the receiving ring. The present disclosure is tailored to small devices with limited space for large coils and additional circuit components. This technology could be adapted to other electronics which are small and cheap.

Smart rings for monitoring health metrics are an emerging consumer device platform. Like all wearable electronic devices, smart rings contain batteries which may be periodically recharged. Smart rings on the market today use either pin or inductive charging. In pin charging, metal pads on the ring contact complementary pads on a charging unit, while in inductive charging, metal coils in the charging unit and ring are aligned to form a transformer, so that current flowing in one coil causes current in the other through inductive coupling. Some advantages of pin charging are ease of design and affordability, while rings with inductive charging have a smoother inner surface and can be more robust to water and dust ingress.

With either method, the charging infrastructure is typically implemented on the inner diameter of the ring. Pins fabricated on the exterior of the ring shell have a poor aesthetic, snag soft or woven materials, and stand a higher chance of damage. Inductive charging is disrupted when conductive materials are placed between the coils, as the magnetic flux will dissipate energy into the conductor in the form of eddy currents. The exterior shell of smart rings is typically metal to minimize scratches and match other jewelry, thus the coil is placed under the dielectric material on the ring's inner surface.

Unlike the majority of wearable devices, the user expectation for a smart ring is for a device that comes in a single size with no adjustable components. To address this, multiple size versions of each smart ring product are typically designed and manufactured. This adds significant complexity and costs, as up to 9 sub-designs may be managed for each ring model (one per finger size), each potentially using different mechanical components, assembly processes, quality control, etc.

The charging base strategy for the product may consider the varying ring sizes. For both pin and inductive charging, the charging unit may be physically aligned with the ring to ensure optimal and consistent performance. The most obvious strategy to guarantee alignment involves a separate charging unit for each ring size, but this extends the cost and complexity penalties indicated above. Many smart rings currently use a short post in relief from the top of the charging base to ensure good mating. The ring is placed onto the base with the post in the center. Typically, there are matching features on the ring interior surface (and post exterior) for rotational alignment. While it is possible to place alignment features on the ring exterior surface, this would likely decrease the aesthetic value of the ring. Permanent magnets in the ring and charging base can also be used for alignment but suffer similar size and complexity problems. In this case the physical shape of the charging post is not used for mechanical alignment and its diameter is not relevant.

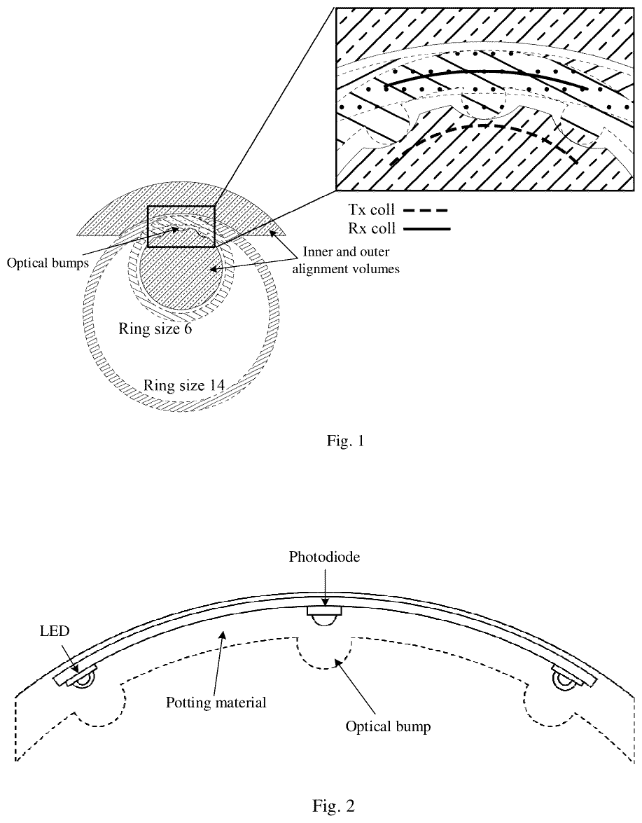

Referring to FIG. 1, an alternative strategy is to “pinch” one section of the ring using two relief volumes. This aligns the ring and transmitter coils and if the pinching structures are appropriately sized, multiple ring sizes could be placed into one transmitter base. While the coil alignment would not be perfect due to their slightly different radii of curvature, it is likely that this design could constitute a universal charger. However, a problem arises in implementation from the nature of the ring alignment features. As shown in FIG. 1, alternative size-agnostic charger design using two alignment volumes. This design would not function well due to the optical bumps interfering with the inductive charging coils.

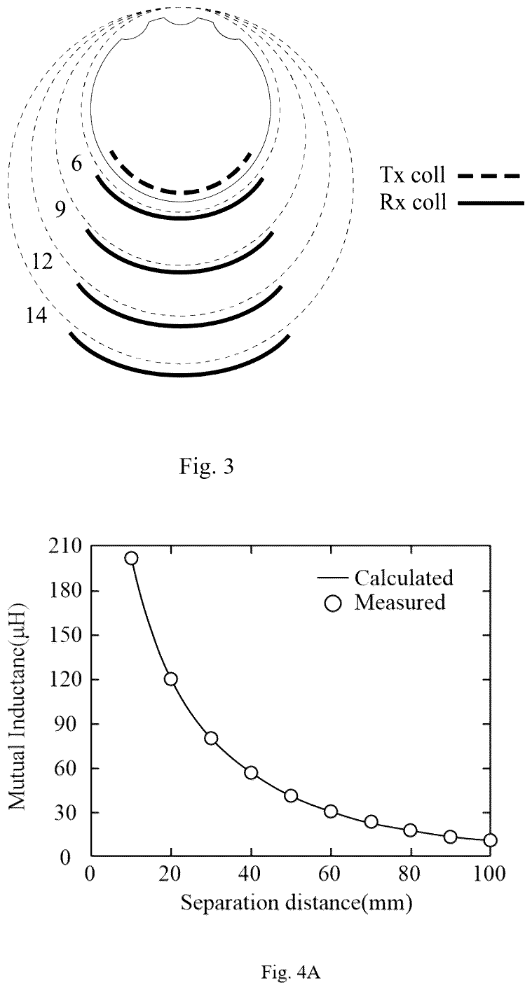

Smart rings typically use an optical interface with the skin in order to capture important health metrics. To achieve this, the inner surface of the ring uses a transparent polymer potting layer to encapsulate the electronics while allowing light to pass. In order to improve the transmission qualities of this interface, bumps can be fabricated in the potting material. These bumps also provide a convenient alignment feature for charging. However, reconsidering the problem of aligning the ring into the pinching relief structures, it is apparent that the presence of the bumps prevents the pinch location from being used to align the transmitting and receiving inductive coils. This is because the receiving coil cannot be placed over the LEDs and photodiodes as it would block light transmission, and cannot be placed under the printed circuit board as the metal in the circuit would block the inductive energy transfer, as shown in FIG. 2.

FIG. 2 shows a horizontal cross section of a smart ring. A flexible PCB contours to the metal shell and optical components are placed on the opposite side or inner diameter of the PCB. There is no space available to add an antenna to this section of the ring. If the antenna was placed inside the PCB, it would block the optical components. If it was placed outside the PCB, wireless power transfer could not occur through the metal.

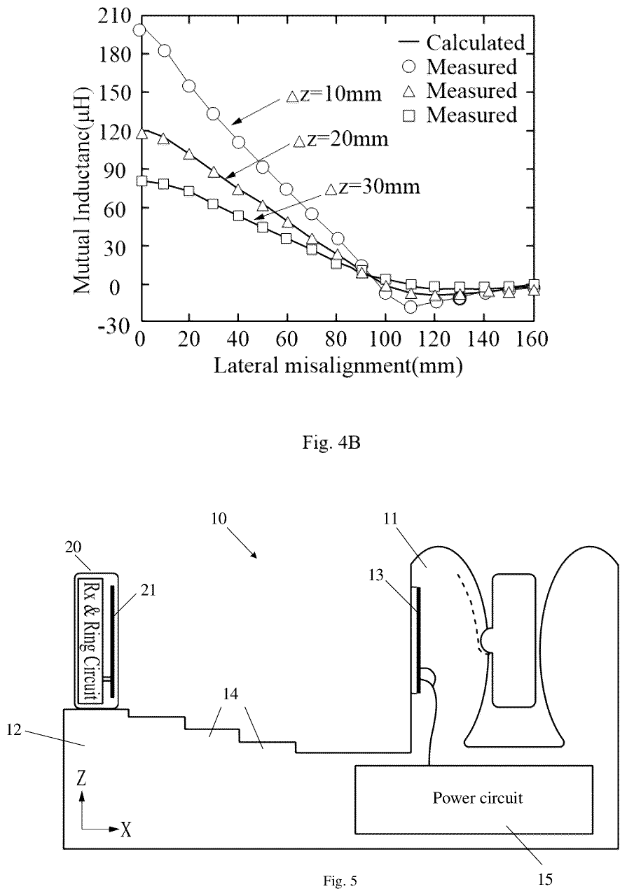

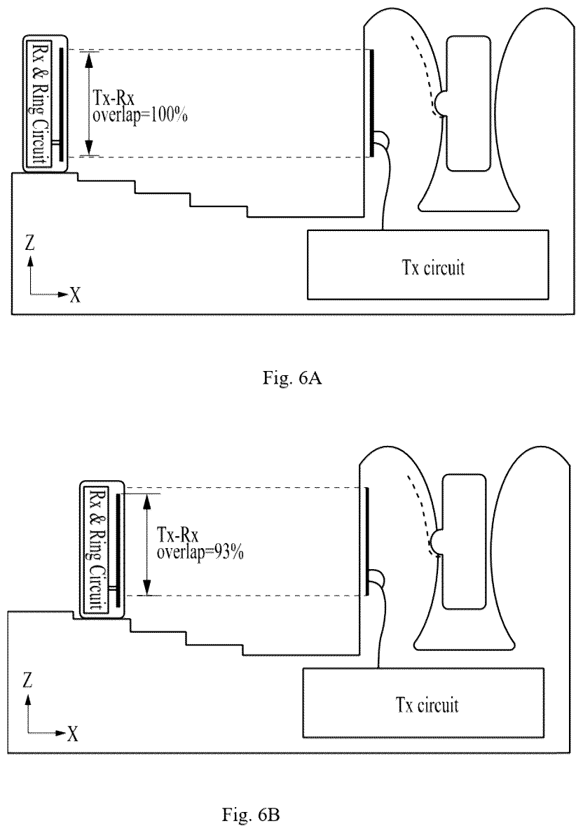

Referring to FIG. 3, if the coils are placed 1800 away from the pinch point, the coils are aligned rotationally, but misaligned coaxially for higher ring sizes. In other words, the distance between coils will be high. This results in decreased coupling and lower mutual inductance between the coils, and therefore higher power loss for the inductively coupled system. All types of misalignment (coaxial, rotational, lateral) between two coils will decrease the mutual inductance, though some types of misalignment are more impactful than others. The analytical expressions to describe this behavior are complex (Eq. (1)), but analysis of the data shows that coaxial misalignment or separation distance has a significant and nonlinear effect on mutual inductance, while lateral misalignment affects mutual inductance in a controlled and linear way (see also FIG. 4):

$$M = \frac{{μ}_{0}}{2 {π}^{2} w δ {w}^{′} {δ}^{′}} {\int }_{- ∞}^{∞} {\int }_{- π}^{π} {e}^{- k Δ z - j k ( Δ x cos ( t ) + Δ y sin ( t ) )} \times sinh ( \frac{δ k}{2} ) sinh ( \frac{{δ}^{′} k}{2} ) {\sum }_{i = 1}^{4} Γ ( r , {β}_{i} , Δθ ) {\sum }_{j = 1}^{4} \overline{Γ} ( {r}^{′} , {β}_{j}^{′} , 0 ) dtdk \qquad Eq . ( 1 )$$

where Δz is separation distance, Δx and Δy are lateral misalignment.

FIG. 3 shows receive coils can be fabricated opposite the optical bumps, but their coaxial misalignment (separation distance) will vary with ring size. The smallest ring size will experience the highest power transfer in this case. The dotted lines represent the inner diameter of the smart ring.

FIG. 4 shows the mutual inductance between two coils is affected by their (a) coaxial and (b) lateral misalignment.

Wireless power transfer systems often include a feedback mechanism to adjust the transmitted power to match the needs of the receiving device. This reduces wasted energy, prevents overheating in the receiver, and minimizes EMI. In the well-known Qi standard, the receiver communicates with the transmitter by modulating the parallel capacitance across the coil, which is detected by a change in the reflected impedance as seen from the primary coil.

This allows for simplex communication. The transmitter then modulates its power to match the receiver—in the Qi protocol, this occurs by frequency adjustment.

The Qi protocol is mostly used in so-called “inductive wireless charging,” where the separation distance is much smaller than the coil diameters and the system is operating in the tightly-coupled regime. Here, close alignment and large coils are used to maximize the coupling factor and quality factor, respectively. In the wearable ring, these systems are inappropriate due to the small space available for the receiving coil. The alternative system is referred to as “resonant wireless charging.” Here, each coil is tuned to identical resonance frequencies which allows for power transfer even at relatively large misalignments. The downside of this loosely-coupled regime is much lower rates of power transfer. While standards for “resonant” charging are much less mature than those for “inductive” charging, these systems can also adjust their transmit power to match the receiver's needs.

The downside of these feedback-based strategies are complexity and cost. Implementing transmitter circuitry which is Qi compliant and able to adjust transmit frequency can be expensive, and adding an additional communication module on the receiving device takes up valuable space and uses power. The safeguards and handshaking built into these protocols were designed for relatively high-power transfer into the tens of watts, which has the potential to cause damage through parasitic heating and energy waste. In certain applications, particularly low-power systems like a wearable ring, such standards can be unnecessary.

In the ring charging system represented by FIG. 3, smaller rings benefit from decreased separation distance from the transmit coil, causing an increase in received power. However, larger rings use the transmitter to either detect the ring size and increase the transmit power accordingly, or use a protocol incorporating feedback so that the receiver can call for more power. Higher power cannot be used for all ring sizes, because that would result in parasitic heating in the smallest ring and would waste energy.

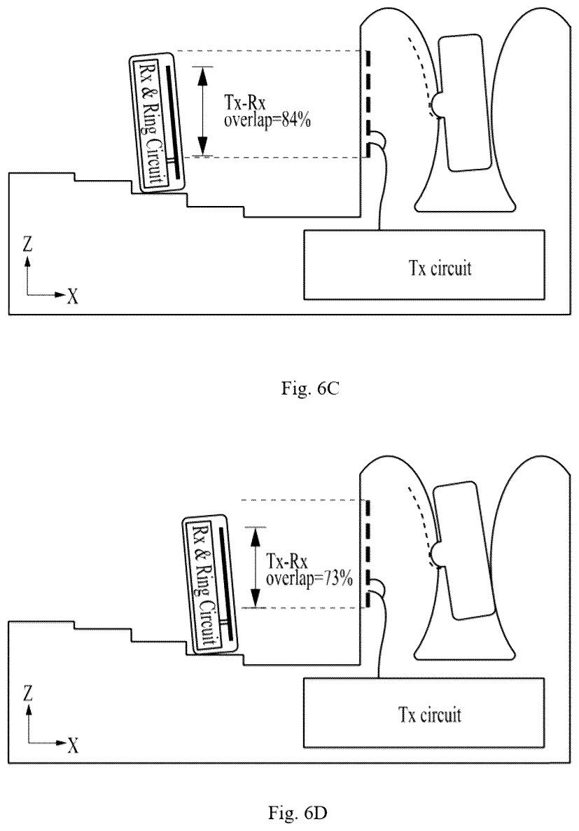

FIG. 5 shows a wireless charger 10 according to an embodiment of the present disclosure. The wireless charger 10 can be applied for different sizes of a wearable device 20 (e.g., a wearable ring). The wireless charger 10 includes a mounting part 11, a charging platform 12, a transmit coil 13 and a power circuit 15. The transmit coil 13 is disposed in the mounting part 11. The mounting part 11 may have an arc surface or is in a form of an hourglass or has a slope for accommodating a separated part of a wearable device 20. The charging platform 12 is adjacent to the mounting part 11. The charging platform 12 is used for placing the wearable device 20 with a receive coil 21. The receive coil 21 may be disposed at a side of the wearable device 20 close to the transmit coil 13. The wireless charger 10 further includes a plurality of steps (e.g. shelves) 14 created on a top surface of the charging platform 12 such that the plurality of steps 14 are at different heights with respect to a horizontal plane. In addition to a flat surface, in some embodiments, each of the steps may have a inclined surface, concave surface or convex surface, which fits an external surface of the wearable device. The wearable device may be placed on the inclined surface, concave surface or convex surface of any one of the steps for charging. The power circuit 15 is coupled to the transmit coil 13 so as to enable the transmit coil 13 to emit electromagnetic waves to the receive coil 21 to charge the wearable device 20. More specifically, the smaller the distance between the steps 14 and the transmit coil 13, the smaller the heights of the steps 14. An overlap of a projection of the receive coil 21 onto the transmit coil 13 is compensated by a separation distance between the receive coil 21 and the transmit coil 13. As the separation distance decreases between the transmit coil 13 and the receive coil 21, the overlap of the projection of the receive coil 21 onto the transmit coil 13 decreases. Please refer below for more details.

In some embodiments, the shape of the surface of the mounting part 11 corresponds to the shape of the surface of the steps 14 and/or the setting of the height of the steps 14, so as to allow a better charging efficiency for different sizes of rings when they are placed on it. The approach proposed herein aims to take advantage of incremental lateral misalignment to physically tune the power transfer into rings of various sizes. By creating small shelves in the relief features on top of the charger unit, rings of decreasing size can be intentionally misaligned. This increase in lateral misalignment can be designed to offset the decrease in separation distance between the receive and transmit coils. Increasing lateral misalignment can also be thought of as the decreasing overlap between the shared projections of each coil. In this way, power transfer is naturally adjusted to the correct level for each ring size without the need for feedback or any size-detection circuit in the transmitter.

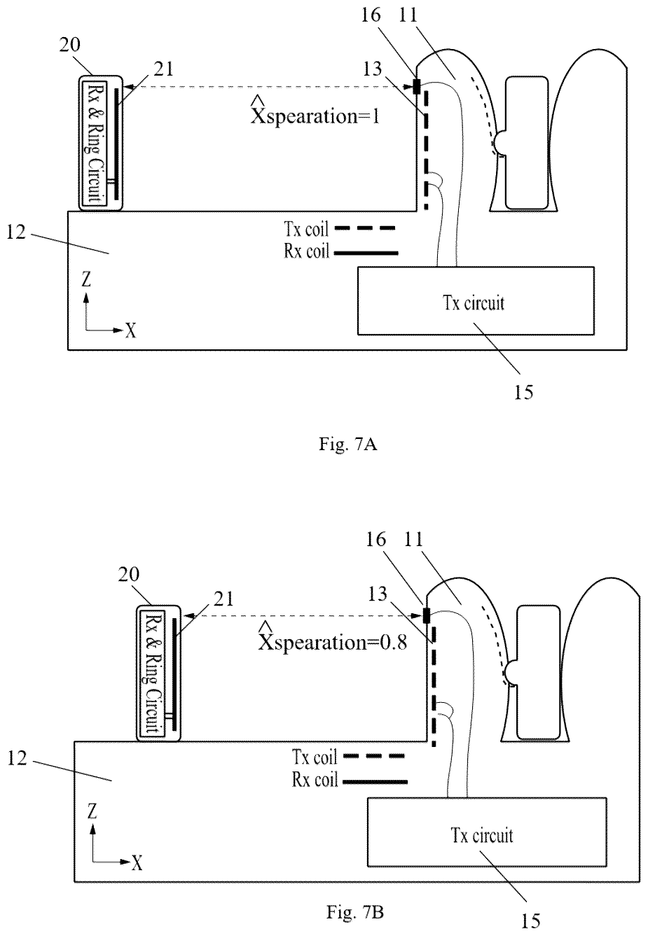

FIG. 6 shows a cross-section of a smart ring and charging base. The section of the ring out of plane behind the page is not shown for clarity. As the separation distance decreases between the transmit (Tx) and receive (Rx) coils, the lateral misalignment (Δz) increases, as indicated by the dotted lines (FIG. 6a to FIG. 6d). The dotted line represents vertical grooves in the charging base to align the ring using the bump, along with a shelf to support the bump.

Modeling and empirical testing should be used to calculate and verify the exact heights of the shelves. Since the effect of lateral misalignment appears linear, the shelving height should inversely track the mutual inductance versus separation distance curve (FIG. 4). Only the side of the ring with the receiving coil will be placed on the shelves. The other side of the ring will be placed into an hourglass-shaped void space to allow the ring to tilt downwards towards the lower shelves. This void space also contains grooves matching the bumps in the ring, which let the ring slot into the void space and keep its rotational alignment. These grooves also curve inwards to support the bumps and pin the aligned side of the ring to a constant height. Such tilting will cause some angular misalignment between the receiving and transmitting coils which will also slightly decrease the power transfer, an effect which increases with decreasing ring size. This effect underscores the need for empirical testing to determine the optimal shelf heights.

The present disclosure enables a cheap universal or size-agnostic charger, which can be manufactured with identical electrical and mechanical components that will function with any ring size. Such an outcome was possible previously using wireless charging standards, but this would use impactful sacrifices in price, space, complexity, and current draw. A wearable ring product in particular uses high space efficiency due to the small amount of total available space. The present disclosure takes advantage of physics principles and simple geometry to achieve comparable results to a standards-based solution at minimal cost. Compared to a universal charger without standards and without shelving, this solution will result in consistent charging rates at any size and minimal parasitic heating of small ring sizes.

The present disclosure should make the logistics of mass production and marketing much simpler for a ring charger product because a single charger can service any ring size. It should also improve the user experience significantly because a single family or group with multiple sizes of wearable rings can share one charger at home or when travelling. It would also simplify the returns process if a customer wanted to exchange their ring for a new size.

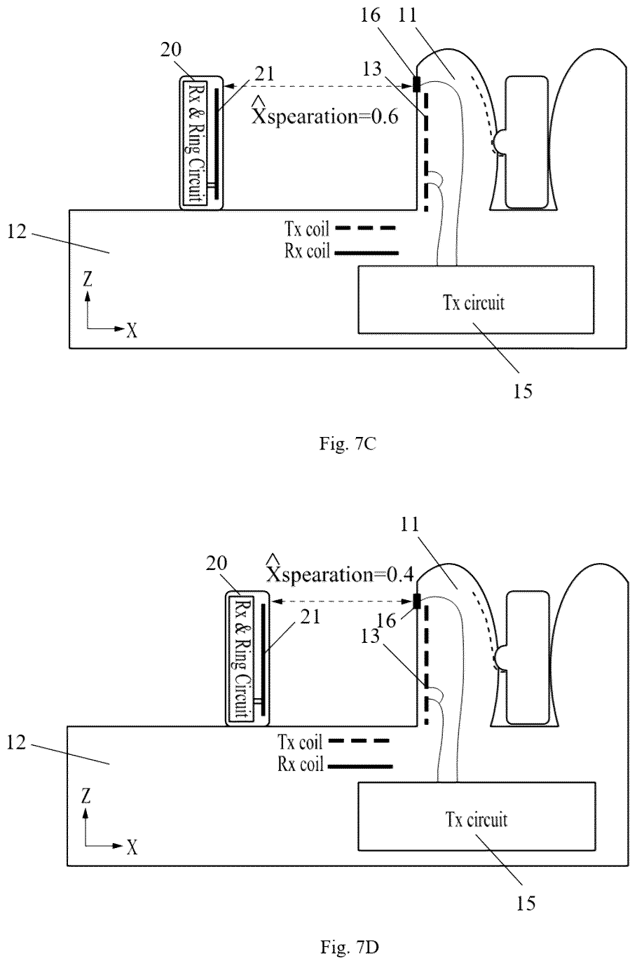

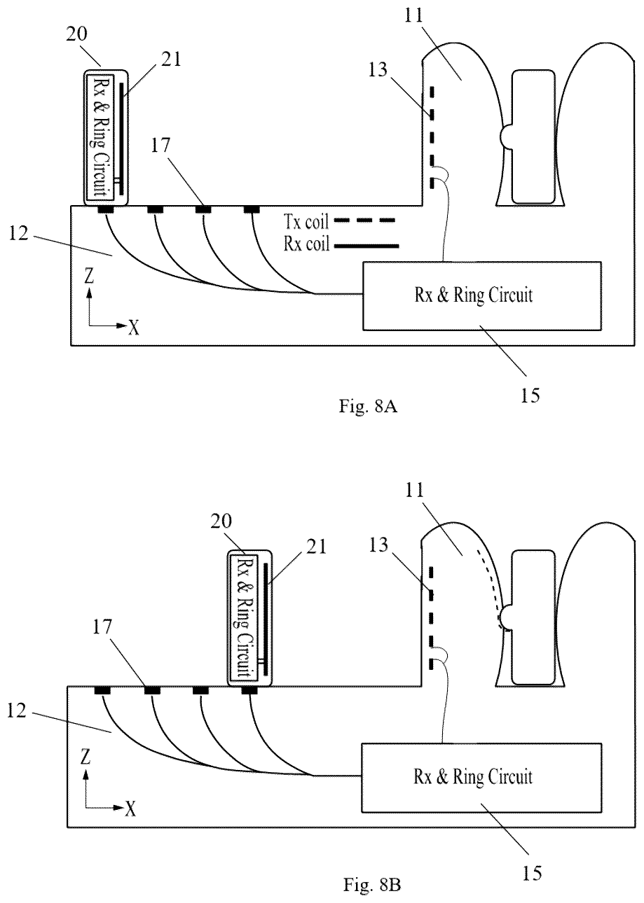

FIG. 7 and FIG. 8 show a wireless charger according to an embodiment of the present disclosure. The wireless charger can be applied for different sizes of a wearable device 20 (e.g., a wearable ring). The wireless charger includes a mounting part 11, a charging platform 12, a transmit coil 13 and a power circuit 15. The transmit coil 13 is disposed in the mounting part 11. The mounting part 11 may have an arc surface or is in a form of an hourglass or has a slope for accommodating a separated part of a wearable device 20. The charging platform 12 is adjacent to the mounting part 11. The charging platform 12 is used for placing the wearable device 20 with a receive coil 21. The receive coil 21 may be disposed at a side of the wearable device 20 close to the transmit coil 13. The wireless charger further includes a distance sensor (see element 16 in FIG. 7 or element 17 in FIG. 8) for obtaining a separation distance between the transmit coil 13 and the receive coil 21. The power circuit 15 is coupled to the transmit coil 13 so as to enable the transmit coil 13 to emit electromagnetic waves to the receive coil 21 to charge the wearable device 20. The power circuit 15 adjusts transmit power based on the separation distance. Referring to FIG. 7, the distance sensor comprises an infrared receiver 16 disposed in the mounting part 11. The infrared receiver 16 receives a signal from an infrared transmitter (not shown) disposed in the wearable device 20 to determine the separation distance. Referring to FIG. 8, the distance sensor comprises multiple indictive proximity sensors 17 disposed beneath the charging platform 12. The separation distance is determined by using the multiple indictive proximity sensors 17 to detect presence of the wearable device 20 with a metal shell. Please refer below for more details.

Active electronic methods can also be used to detect the ring size and adjust power accordingly. In one instantiation, a single infrared distance sensor can be built into the transmitter housing to calculate the separation distance (FIG. 7), represented by the normalized distance \hat{x}ₛₑₚₐᵣₐₜᵢₒₙ here. The transmit power could then be lowered as \hat{x}ₛₑₚₐᵣₐₜᵢₒₙ decreased. A similar instantiation could use multiple inductive proximity sensors built into the base and facing upwards in z to detect the presence of the metal ring shell and estimate \hat{x}ₛₑₚₐᵣₐₜᵢₒₙ (FIG. 8). These methods would be beneficial because they don't use any additional components in the ring circuit, where space is at a premium. However, they still use an increased BOM cost in the transmit unit, because additional sensors and circuitry to adjust the transmit power may all be included. These strategies may also face regulatory and safety challenges because it is possible for the user to “fool” these sensors with foreign objects which could result in unwanted power transfer to and parasitic heating of said objects.

As shown in FIG. 7, an infrared distance sensor instrument can be used to estimate the normalized separation distance between the Tx and Rx coils (\hat{x}ₛₑₚₐᵣₐₜᵢₒₙ). The distance can be calculated with a time-of-flight method between the IR emitter and receiver, both of which are colocated in the instrument.

As shown in FIG. 8, Inductive proximity sensors can be used to detect the metal ring housing and thereby estimate \hat{x}ₛₑₚₐᵣₐₜᵢₒₙ.

Again considering passive strategies, there are other types of misalignment which could be intentionally applied to the charging system to tune the power transfer between the transmit and receive coils. For example, a system could be designed to rotationally misalign the ring, perhaps by designing a curving groove for the alignment bumps.

As described earlier, an active, standards-based charging strategy could also be effective with increased separation distance between coils. However, this would result in likely >$10 increased BOM cost between the ring and charger while bringing minimal benefits for this application.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. A wireless charger, comprising:
a mounting part;
a transmit coil, disposed in the mounting part;
a charging platform, adjacent to the mounting part, for placing a wearable device with a receive coil;
a plurality of steps created on a top surface of the charging platform such that the plurality of steps are at different heights with respect to a horizontal plane; and
a power circuit, coupled to the transmit coil to enable the transmit coil to emit electromagnetic waves to the receive coil to charge the wearable device.

2. The wireless charger of claim 1, wherein the smaller the distance between the steps and the transmit coil, the smaller the heights of the steps.

3. The wireless charger of claim 1, wherein an overlap of a projection of the receive coil onto the transmit coil is compensated by a separation distance between the receive coil and the transmit coil.

4. The wireless charger of claim 3, wherein as the separation distance decreases between the transmit coil and the receive coil, the overlap of the projection of the receive coil onto the transmit coil decreases.

5. The wireless charger of claim 1, wherein the receive coil is disposed at a side of the wearable device close to the transmit coil.

6. The wireless charger of claim 1, wherein each of the steps has a concave surface or convex surface, on which the wearable device is placed.

7. The wireless charger of claim 1, wherein the mounting part is in a form of an hourglass.

8. The wireless charger of claim 1, wherein the wireless charger is for different sizes of the wearable device.

9. The wireless charger of claim 1, wherein the wearable device is a wearable ring.

10. A wireless charger, comprising:
a mounting part;
a transmit coil, disposed in the mounting part;
a charging platform, adjacent to the mounting part, for placing a wearable device with a receive coil;
a distance sensor, for obtaining a separation distance between the transmit coil and the receive coil; and
a power circuit, coupled to the transmit coil to enable the transmit coil to emit electromagnetic waves to the receive coil to charge the wearable device, wherein the power circuit adjusts transmit power based on the separation distance.

11. The wireless charger of claim 10, wherein the distance sensor comprises an infrared receiver disposed in the mounting part.

12. The wireless charger of claim 11, wherein the infrared receiver receives a signal from an infrared transmitter disposed in the wearable device to determine the separation distance.

13. The wireless charger of claim 10, wherein the distance sensor comprises multiple indictive proximity sensors disposed beneath the charging platform.

14. The wireless charger of claim 13, wherein the separation distance is determined by using the multiple indictive proximity sensors to detect presence of the wearable device with a metal shell.

15. The wireless charger of claim 10, wherein the receive coil is disposed at a side of the wearable device close to the transmit coil.

16. The wireless charger of claim 10, wherein the mounting part is in a form of an hourglass.

17. The wireless charger of claim 10, wherein the wireless charger is for different sizes of the wearable device.

18. The wireless charger of claim 10, wherein the wearable device is a wearable ring.
